(19) United States
(12) Patent Application Publication
(10) Pub. No.: US 2007/0234518 A1
(43) Pub. Date: Oct. 11, 2007

(54) Linear hinge

(75) Inventor: Jia-Hao Hsu, Shulin City (TW)

Correspondence Address: Thomas E. Sisson;Jackson Walker, LLP, Suite 2100, 112 E. Pecan, San Antonio, TX, 78205, US

(73) Assignee: Shin Zu Shing Co., Ltd.

(21) Appl. No.: 11/400,136

(22) Filed: Apr. 7, 2006

(51) Int. Cl. E05D 11/08

(52) U.S. Cl. 16/342

(57) ABSTRACT

A linear hinge has a sleeve, a bar and a pintle. The sleeve is tubular and has a mounting protrusion. The bar is mounted in the sleeve and has one end and a mounting recess corresponding to and engaging the mounting protrusion. The pintle has an outside rod and an inside rod. The inside rod is mounted rotatably in the sleeve and has an end and an outer surface. The bar has a positioning hole formed in the end of the bar and the inside rod of the pintle has a positioning stub extending from the end of the inside rod and corresponding to and mounted in the positioning hole. Therefore, the pintle is held in the sleeve without axially departing from the sleeve and is sturdy when the pintle pivots. Thus, a utility life of the hinge will be prolonged.

### BACKGROUND OF THE INVENTION

1. Field of Invention

The present invention relates to a linear hinge, and more particularly to a linear hinge that is sturdy to prolong a utility life.

2. Description of the Related Art

A linear hinge is usually mounted between two appliances and pivots to change relative positions between the two appliances. With reference to FIGS. 4 and 5, a conventional hinge is mounted between two appliances and has multiple holding elements, a sleeve (5), a bar (4) and a pintle (6). The sleeve (5) is tubular and has a mounting protrusion (51). The bar (4) is mounted in the sleeve (5) and has multiple pivot holes (41) and a mounting recess (42). The pivot holes (41) provides the holding elements to extend through and mount in to connect to one of the appliances. The mounting recess (42) corresponds to the mounting protrusion (51) and engages the mounting protrusion (51), so the bar (4) and the sleeve (5) connect to each other firmly. The pintle (6) has an outside rod (60) and an inside rod (62). The outside rod (60) has multiple pivot through holes (61) providing the holding elements to extend through and mount in to connect to the other appliance. The inside rod (62) is mounted rotatably in the sleeve (5) and has an outer surface and an oil groove (63) formed around the outer surface of the inside rod (62). However, the hinge cannot hold the pintle (6) firmly in the sleeve (5) so the inside rod (62) of the pintle (6) easily separates from the sleeve (5) and the conventional hinge does not work normally. Therefore, the abnormal working of the conventional hinge decreases the utility life of the conventional hinge.

To overcome the shortcomings, the present invention provides a linear hinge to mitigate or obviate the aforementioned.

### SUMMARY OF THE INVENTION

The primary objective of the present invention is to provide a linear hinge that is sturdy to prolong a utility life.

To achieve the objective, a linear hinge has a utility life, a sleeve, a bar and a pintle. The sleeve is tubular and has a mounting protrusion. The bar is mounted in the sleeve and has one end and a mounting recess corresponding to and engaging the mounting protrusion. The pintle has an outside rod and inside rod. The inside rod is mounted rotatably in the sleeve and has an end and an outer surface. The bar further comprises a positioning hole formed in the end of the bar and the inside rod of the pintle further comprises a positioning stub extending from the end of the inside rod and corresponding to and mounted in the positioning hole of the bar. Therefore, the pintle is held in the sleeve without axially departing from the sleeve and is sturdy when the pintle pivots. Thus the utility life of the hinge will be prolonged.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a linear hinge in accordance with the present invention;

FIG. 2 is an exploded perspective view of the hinge in FIG. 1;

FIG. 3 is a side view in partial section of the linear hinge in FIG. 1;

FIG. 4 is a perspective view of a conventional linear hinge in accordance with the prior art; and

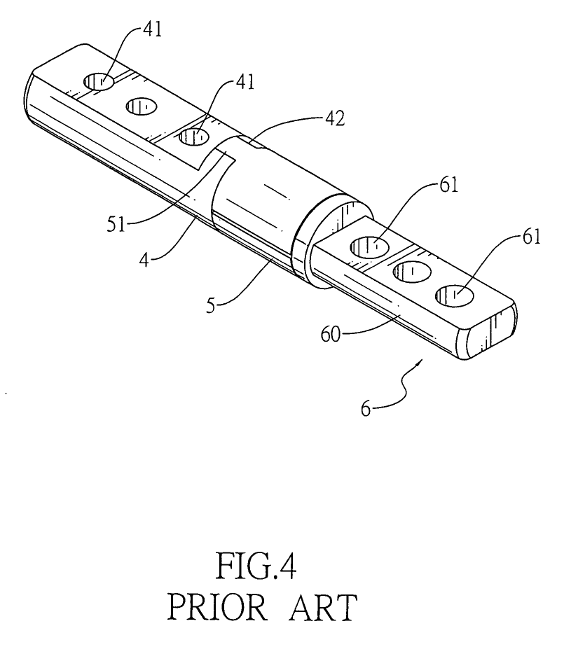

FIG. 5 is a side view in partial section of the conventional linear hinge in FIG. 4.

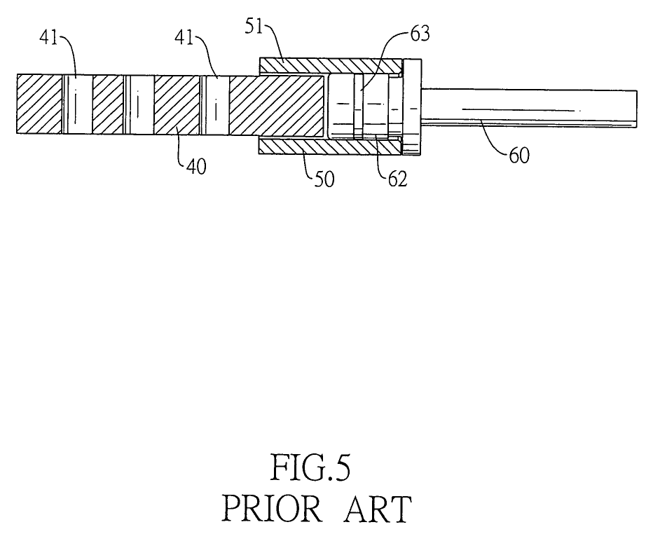

### DETAILED DESCRIPTION OF THE INVENTION

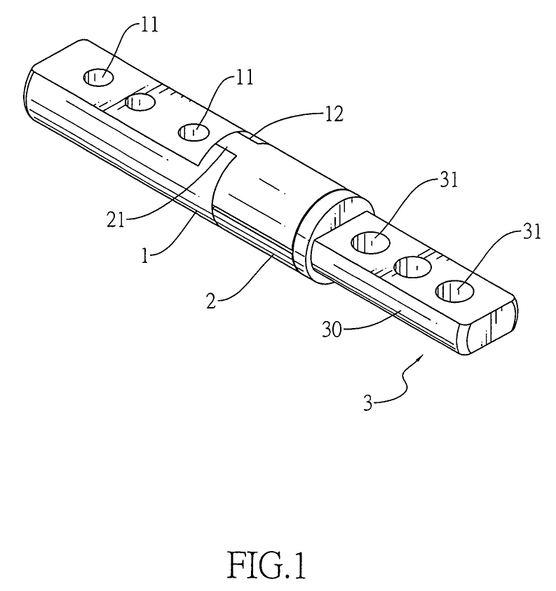

With reference to FIG. 1, a linear hinge in accordance with the present invention is mounted between two appliances and has a sleeve (2), a bar (1) and a pintle (3).

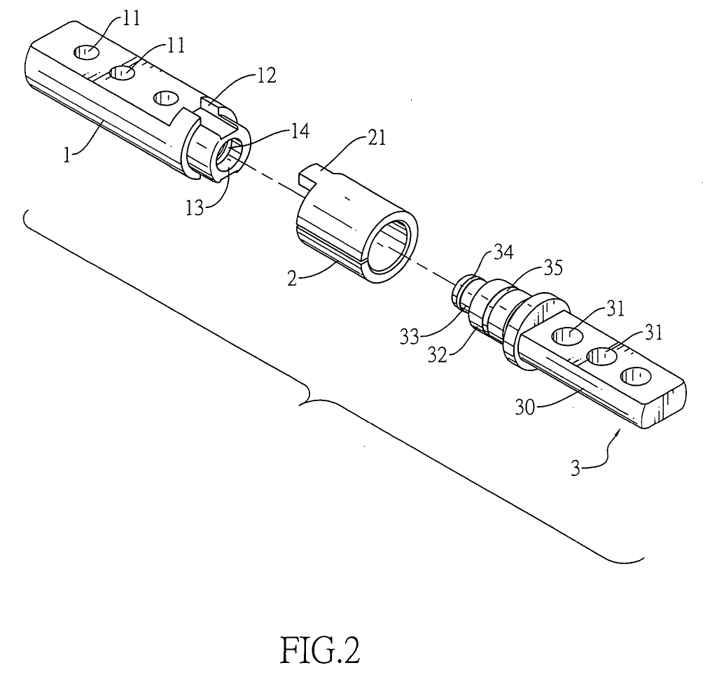

With further reference to FIG. 2, the sleeve (2) is tubular and has a mounting protrusion (21) extending axially out of the sleeve (2).

The bar (1) is mounted in the sleeve (2) and has an end, multiple pivot holes (11) and a mounting recess (12). The pivot holes (11) is formed through the bar (1) and provides multiple holding elements to extend through and mount in to connect to one of the appliances. The mounting recess (12) is formed longitudinally in the bar (1) and corresponds to and engages the mounting protrusion (21) so the bar (1) and the sleeve (2) connect to each other firmly.

The pintle (3) has an outside rod (30) and an inside rod (32). The outside rod (30) has multiple pivot through holes (31) formed through the outside rod (30) and providing multiple holding elements to extend through and mount in to connect to the other appliance. The inside rod (32) is mounted rotatably in the sleeve (20) and has an end , an outer surface and an optional oil groove (35). The oil groove (35) is formed around the outer surface of the inside rod (32) of the pintle (3).

The improvement of the hinge is the bar (1) further comprising a positioning hole (13) formed in the end of the bar (1) and the inside rod (32) of the pintle (3) further comprising a positioning stub (33) extending from the end of the inside rod (32) and corresponding to and mounted in the positioning hole (13) so the pintle (3) protrudes into the sleeve (2) and the bar (1).

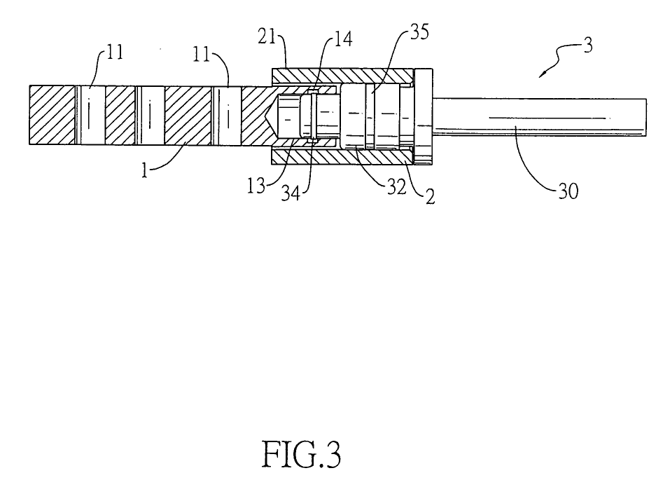

With further reference to FIG. 3, the positioning hole (13) further has an inner surface and at least one annular groove (14) formed in the inner surface. The positioning stub (33) further has an outer surface and a least one annular protrusion (34) formed on the outer surface of the positioning protrusion (33) and corresponding to and mounted in the annular groove (14) in the positioning hole (13). Therefore, the bar (1) keeps the pintle (3) from axially separating out of the bar (1).

Because the positioning stub (33) of the pintle (3) is held in the positioning hole (13) in the bar (1), the pintle (3) is held in the sleeve (2) and the bar (1) without axially departing from the sleeve (2) and the bar (1) and is sturdy when the pintle (3) rotates and the utility life of the hinge will be prolonged.

Even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A linear hinge having
a sleeve being tubular and having a mounting protrusion extending out of the sleeve;
a bar mounted in the sleeve and having
an end;
multiple pivot holes formed through the bar;
a mounting recess formed in the bar and corresponding to and engaging the mounting protrusion of the sleeve; and
a positioning hole formed on the end of the bar; and
a pintle rotatably mounted on the sleeve and having
an outside rod having multiple pivot through holes formed through the outside rod; and
an inside rod mounted rotatably in the sleeve and having
an end; and
an outer surface; and
a positioning stub extending from the end of the inside rod and corresponding to and mounted in the positioning hole of the bar.

2. The linear hinge as claimed in claim 1, wherein
the positioning hole of the bar further has
an inner surface; and
an annular groove formed in the inner surface of the positioning hole of the bar; and
the positioning stub of the pintle further has
an outer surface; and
an annular protrusion formed on the outer surface of the positioning protrusion and corresponding to and mounted in the annular groove in the positioning hole.

3. The linear hinge as claimed in claim 1, wherein the inner rod further has an oil groove formed in the outer surface of the inside rod of the pintle.
